(19) United States
(12) Patent Application Publication
(10) Pub. No.: US 2009/0194522 A1
(43) Pub. Date: Aug. 6, 2009

(54) CORDLESS WARMER

(76) Inventor: Kevin P. Connolly, Venice, FL (US)

Correspondence Address: NW-IP-LAW, 6039 E. Grant RD., Tucson, AZ, 85712, US

(21) Appl. No.: 12/024,728

(22) Filed: Feb. 1, 2008

(51) Int. Cl. H05B 3/06

(52) U.S. Cl. 219/521

(57) ABSTRACT

The present invention is directed to a cordless warmer apparatus including an interchangeable upper bowl, a base-stand, a heating element, and a power source to allow a person to keep food warm over a long period of time. The upper bowl and lower stand are releasably attached. A user can fill the upper bowl with food or liquid and attach the upper bowl to the base-stand. The power source provides electrical power to the heating element that is housed within the base-stand.

### FIELD OF THE INVENTION

The present invention is directed to a cordless warmer apparatus which has an interchangeable upper bowl, a lower stand, a heating element, and a power source to allow a person to keep the food or liquid warm over a long period of time.

### BACKGROUND OF THE INVENTION

A person often desires to keep food or liquid warm as they are eating or entertaining. Furthermore, a person desires to have the ability to serve food or liquid in an appealing apparatus, while simultaneously keeping the food or liquid hot for a long period of time. Lastly, a person may desire to have a food or liquid warmer that is washable, convenient to use, durable, and lightweight.

Therefore, there is a need for a cordless warmer that allows a person to serve food or liquid in an appealable apparatus while simultaneously keeping the food or liquid hot for a long period of time.

### SUMMARY OF THE INVENTION

A food warming apparatus, comprising an interchangeable upper bowl, wherein the base of the interchangeable bowl has protrusion, a base-stand having an opening to snugly receive the protrusion of the interchangeable upper bowl, a heating element attached to the inner portion of said base-stand, wherein the heating element provides heat to the base of the interchangeable bowl, a housing compartment located within the base-stand, the housing compartment having space for a rechargeable battery unit, control circuitry, and the electrical connection hardware, and a removable power cord attached to the base-stand, wherein the removable power cord charges said rechargeable battery unit. The interchangeable upper bowl has different container shapes.

The housing compartment includes the followings: hardware components to retain at least one rechargeable battery, an electronic control circuitry, and electrical connections between the rechargeable battery, the control circuitry and the external power source.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is an illustration of a warmer according to the invention including an upper bowl, a lower stand, and a power source.

FIG. 2 is an illustration of a warmer according to the invention including an upper bowl, a lower stand, a power source, and a heating element.

FIG. 3 is a top view of the heating element of FIG. 2.

FIG. 4A is a cross-sectional view of the warmer of FIG. 1. FIG. 4B shows an exemplary circuitry of the heating element and its connection to the battery.

FIG. 5 is a bottom view of the warmer of FIG. 1.

FIG. 6 is an illustration of a warmer according to the invention showing the upper bowl and the base-stand separated.

FIG. 7A-7D show the various bowls that could be placed on top of the base-stand.

### DESCRIPTION OF PREFERRED EMBODIMENTS

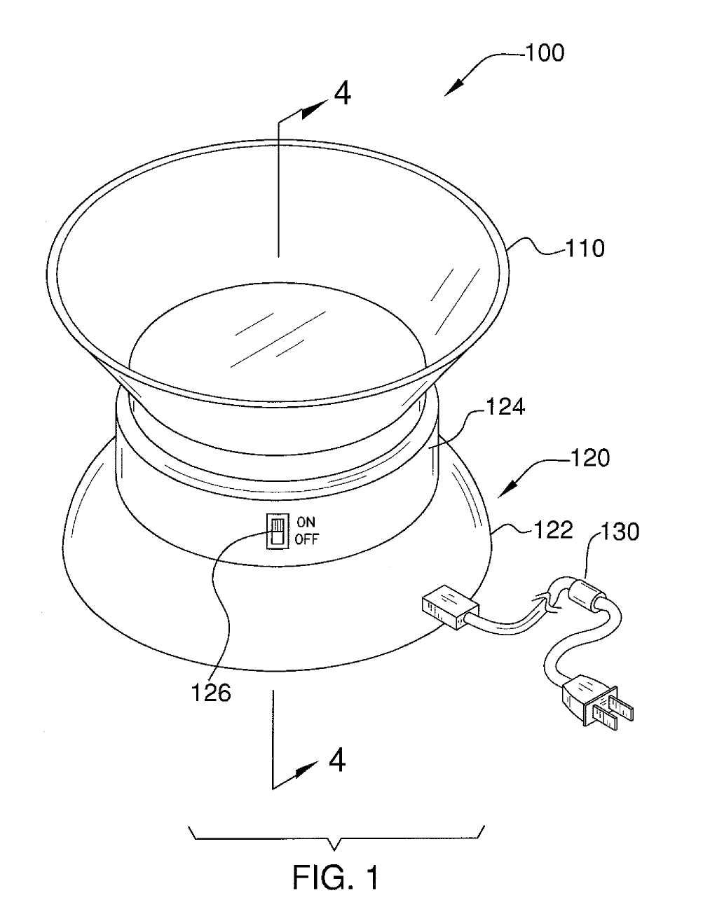

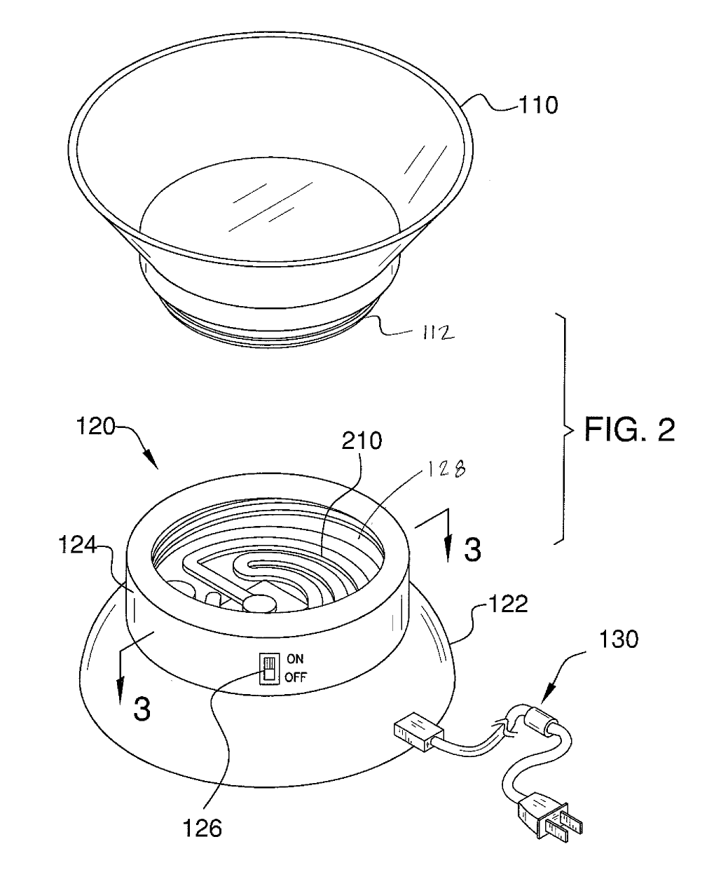

Referring now to FIG. 1, warming apparatus 100 comprises an interchangeable upper bowl 110, base-stand 120, and power source 130. In the illustrated embodiment of FIG. 1, base-stand 120 comprises bottom portion 122 and upper portion 124. In the illustrated embodiment of FIG. 1, the interchangeable upper bowl 110 and the base-stand 120 are releasably connected. In certain embodiments, upper bowl 110 and upper portion 124 comprise a threaded top portion and threaded bottom portion, respectively (see FIG. 2). In some embodiments, the upper bowl 110 comprises a protrusion 112 that can snugly fit into the opening 128 of the upper portion 124. A person can fill upper bowl 110 with food or liquid and attach upper bowl 110 to upper portion 124 by twisting upper bowl 110 onto upper portion 124 using the threaded portions. In other embodiments, upper bowl 110 and upper portion 124 snap together or screw together. In other embodiments, upper bowl 110 and upper portion 124 are molded such that upper bowl 110 fits within upper portion 124. Power source 130 provides power to heating source 210 to keep the food or liquid contained within upper bowl 110 at a hot temperature for a long period of time (see FIG. 1).

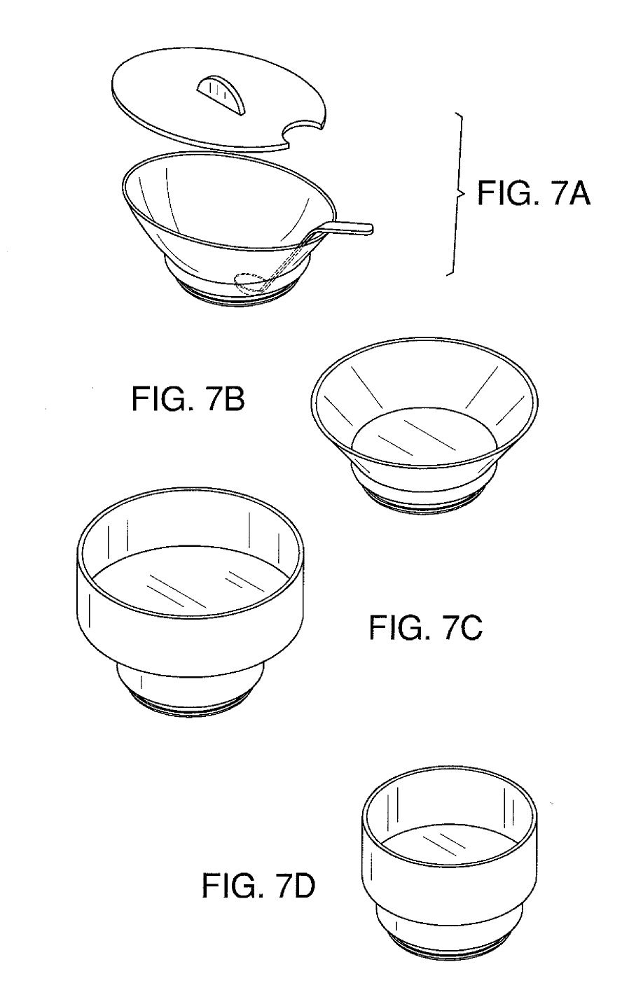

The interchangeable upper bowl 110 may be of any shape. For example, the bowl 110 may be a shape of a boat, a cylinder, a cone, etc. (see FIG. 7). A user may select the appropriate bowl 110 for the occasion.

In certain embodiments, the interchangeable upper bowl 110 comprises a rigid material selected from the group consisting of metal, plastic, glass, ceramic or combinations thereof. In certain embodiments, upper bowl 110 comprises a cone-shaped container with a top rim diameter between about 5 inches and about 6 inches and a bottom rim diameter between about 3 inches and about 4 inches. In certain embodiments, upper bowl 110 comprises a height between about 5 inches and about 7 inches. In other embodiments, upper bowl 110 comprises a square-shaped container.

In certain embodiments, upper portion 12 and bottom portion 122 are molded together to form one object. In certain embodiments, upper portion 124 and bottom portion 122 comprise a rigid material selected from the group consisting of metal, plastic, or combinations thereof. Power cord 130 is used to connect the cordless warmer to the power mains for recharging the battery unit residing within the base-stand or to operate the cordless warmer. A power switch with indicator light 126 is located on the base-stand 120 and is electrically connected to the control circuitry residing inside the base-stand. In some embodiments, the unit is designed to charge a battery and be disconnected for mobility without the need for a power cord.

Referring now to FIG. 2, warming apparatus 100 comprises upper bowl 110, lower stand 120, power cord 130, and heating element 210. In the illustrated embodiment of FIG. 2, upper bowl 110 is detached from lower stand 120. In the illustrated embodiment of FIG. 2, heating element 210 comprises a standard heating element known to one skilled in the art. Heating element 210 is housed within lower stand 120. When a person fills upper bowl 110 with food or liquid, the person attaches upper bowl 110 on lower stand 120. Heating element 210 is turned on and off by the power switch 126 and the food or liquid within upper bowl 110 retains the heat from heating element 210. In some embodiments, the energy for the heat is extracted from a battery source without the need of a power cord.

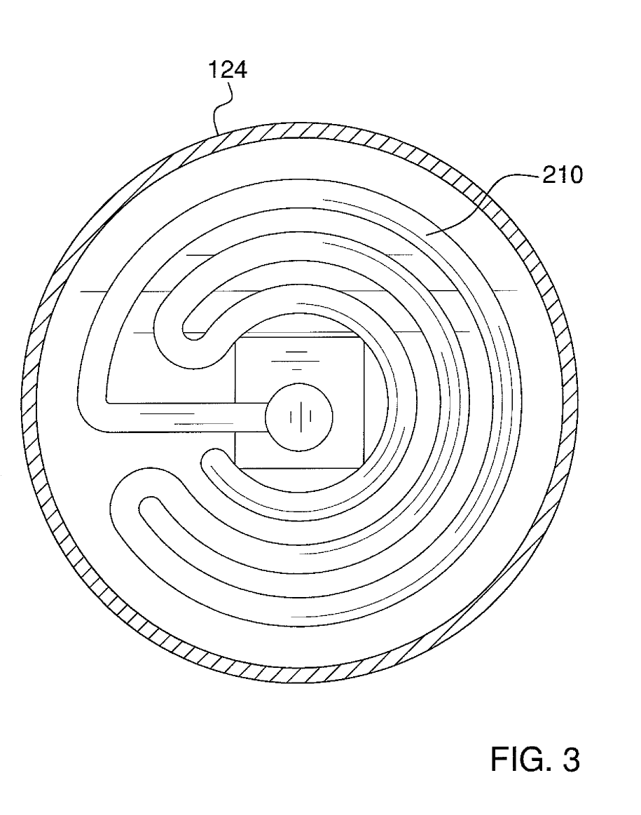

Referring now to FIG. 3, a top view of warming apparatus 100 is shown comprising bottom portion 122 and heating element 210. In the illustrated embodiment of FIG. 3, heating element 210 comprises a standard heating element known to one skilled in the art.

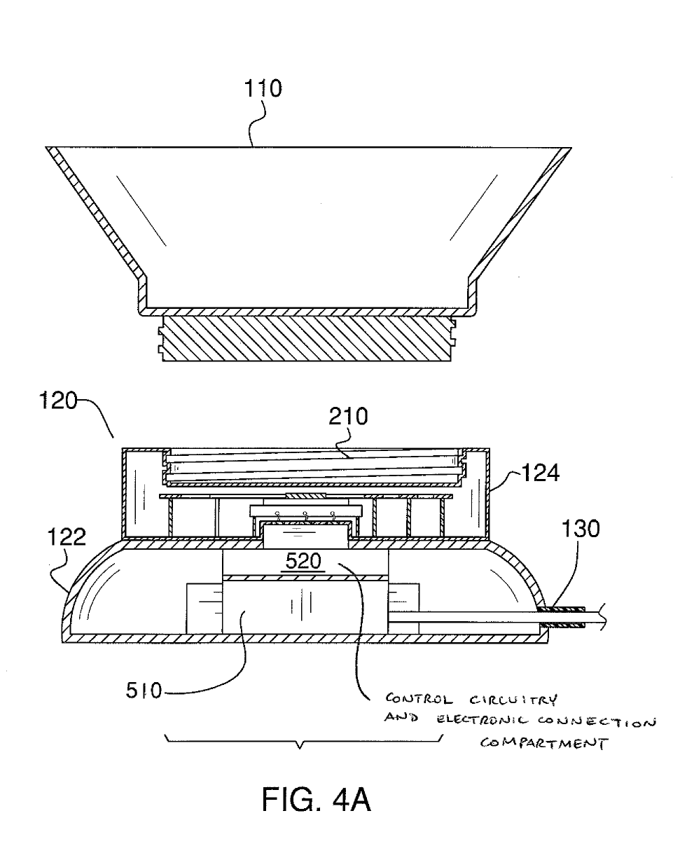

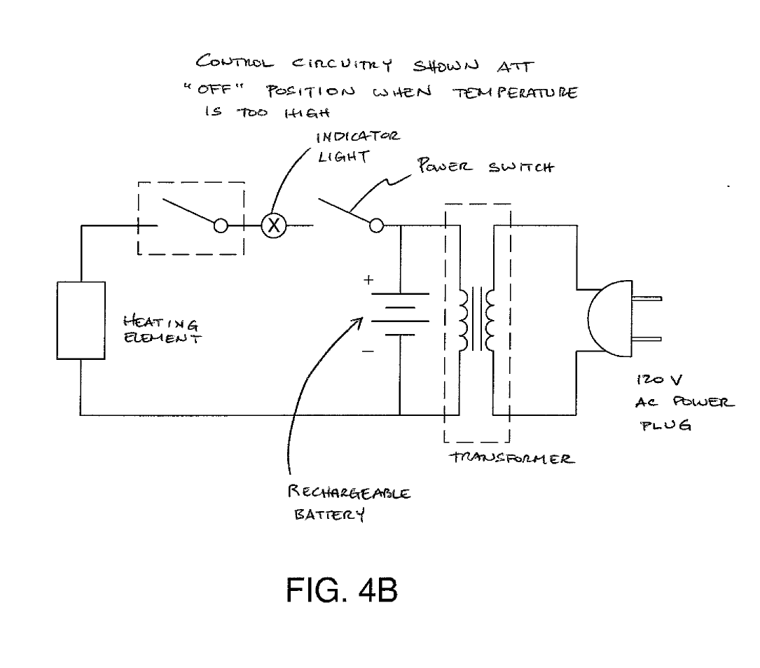

Referring now to FIG. 4A, a cross-section view of warming apparatus 100 is shown comprising upper bowl 110, base-stand 120, power cord 130, and heating element 210, rechargeable battery compartment 510, and control circuitry and electronic connections compartment 520. In the illustrated embodiment of FIG. 4A, base-stand 120 comprises upper portion 124 and bottom portion 122. In the illustrated embodiment of FIG. 4A, heating element 210 comprises a standard heating element known to one skilled in the art.

The battery/electronic compartment provides housing hardware and space for a rechargeable battery unit. The electrical connection leads from the battery housing and the control circuitry and other electrical connection is hidden in the space behind the housing, which is the control circuitry and electronic connections compartment 520. The battery compartment 510 is covered by a removable plastic lid to conceal the rechargeable battery unit from the environment.

Rechargeable batteries can be restored to full charge by external electrical energy source. Rechargeable batteries are categorized according to the consisting chemicals that store and release electrical energy. Commonly used chemicals include lead and sulfuric acid, nickel cadmium (NiCd), nickel metal hydride (NiMH), lithium ion (Li-ion), and lithium ion polymer (Li-ion polymer). In some embodiments, the rechargeable battery unit for the cordless warmer will comprises multiple battery cells that in combination can provide the necessary power for the heating element of the cordless warmer to operate at the desired temperature (for example, 150° F.) and time span (for example, 2 hours). The appropriate combination for the battery unit can be determined by one skilled in the art in accordance with the power output of the heating element for maintaining the desired temperature for the desired time span.

When the cordless warmer is turned on by putting the power switch 126 at the ‘ON’ position, the control circuitry will allow an appropriate current to flow from the battery unit to the heating element 210 to generate the heat for warming the upper bowl 110. A temperature sensor can also be included in the control circuitry that can sense the temperature of the heating element or its surrounding. The control circuitry, with the appropriate design as would be known to one skilled in the art, can turn off the current when the measured temperature rise above a preset upper temperature, and turn back on the current when the measured temperature falls below a preset lower temperature. The cordless warmer can be turned off by putting the power switch 126 at the ‘OFF’ position. In some embodiments, the circuitry design is similar to that disclosed in WO/2006/040540, the disclosure of which is incorporated in its entirety by reference herein.

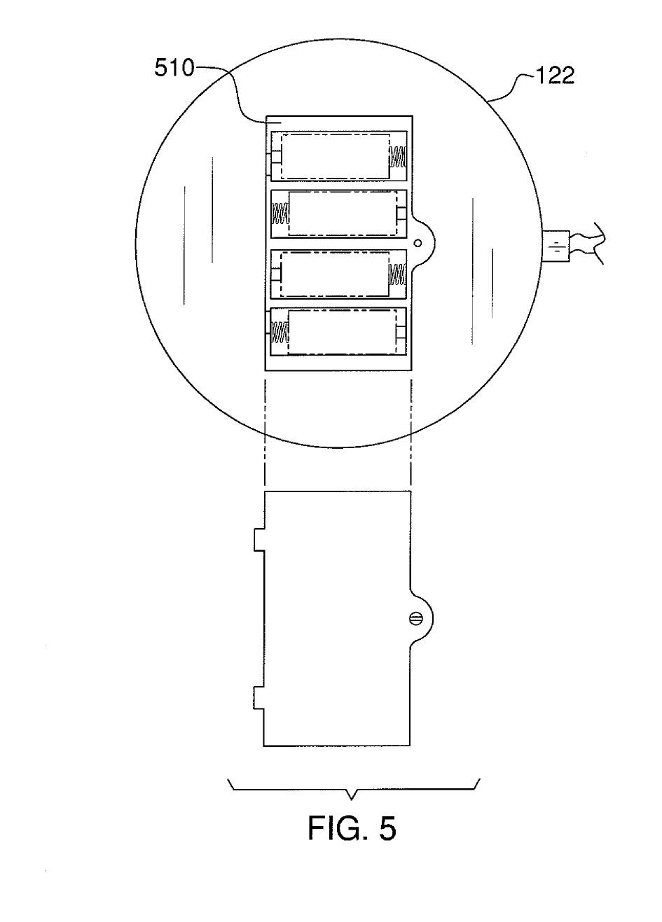

Referring now to FIG. 5, a bottom view of warming apparatus 100 is shown comprising bottom portion 122 and the battery/electronic compartment 510. In the illustrated embodiment of FIG. 5, the rechargeable battery unit fits within bottom portion 122 and provides power to heating element 210 (see FIG. 2). When heating element 210 is turned on, the food and liquid within upper bowl 110 warms up to keep the food or liquid warm.

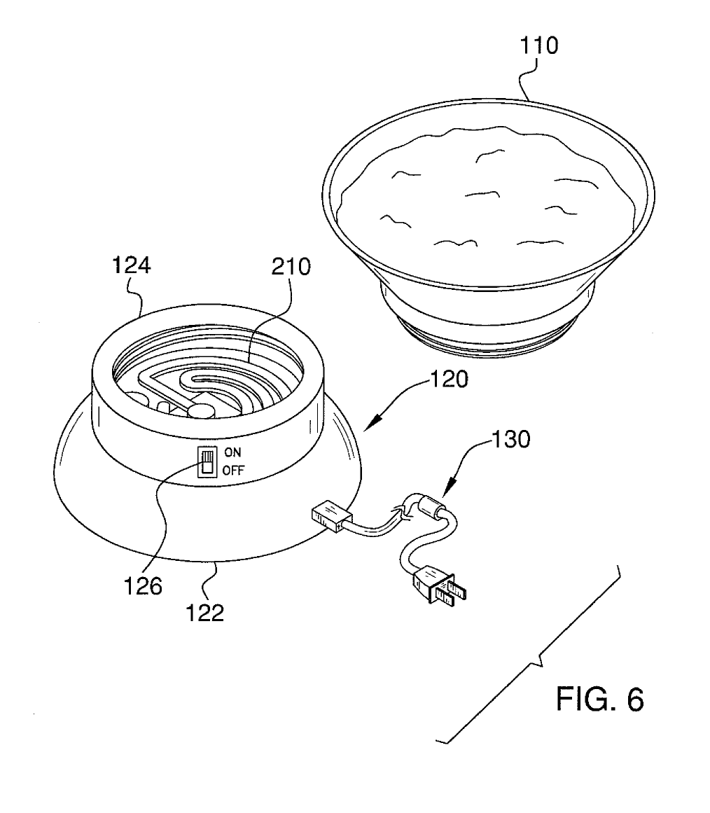

Referring now to FIG. 6, warming apparatus 100 comprises upper bowl 110, base-stand 120, power cord 130, and heating element 210. In the illustrated embodiment of FIG. 2, upper bowl 110 is detached from lower stand 120 and food or liquid is placed within upper bowl 110. In the illustrated embodiment of FIG. 2, heating element 210 comprises a standard heating element known to one skilled in the art. Heating element 210 is housed within lower stand 120. When a person fills upper bowl 110 with food or liquid, the person attaches upper bowl 110 on lower stand 120. Heating element 210 is turned on using power switch 126 and the food or liquid within upper bowl 110 retains the heat from heating element 210.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A food warming apparatus, comprising:
an interchangeable upper bowl, wherein the base of the interchangeable bowl has protrusion,
a base-stand having an opening to snugly receive the protrusion of the interchangeable upper bowl,
a heating element attached to the inner portion of said base-stand, wherein the heating element provides heat to the base of the interchangeable bowl,
a housing compartment located within the base-stand, the housing compartment having space for a rechargeable battery unit, control circuitry, and the electrical connection hardware; and
a removable power cord attached to the base-stand, wherein the removable power cord charges said rechargeable battery unit.

2. The food warming apparatus of claim 1 wherein the interchangeable upper bowl has different container shapes.

3. The warming apparatus of claim 1, wherein said protrusion of said interchangeable upper bowl further comprises a threaded portion.

4. The warming apparatus of claim 1, wherein said opening comprises a threaded portion which can receive the threaded portion of the protrusion.

5. The warming apparatus of claim 1, wherein said power source comprises a rechargeable battery unit.

6. The warming apparatus of claim 1, wherein said power source comprises a power cord to recharge the rechargeable battery unit.
